(19) United States
(12) Patent Application Publication
(10) Pub. No.: US 2024/0393995 A1
(43) Pub. Date: Nov. 28, 2024

(54) HANDHELD NAVIGATION DEVICE

(71) Applicant: BAE Systems Information and Electronic Systems Integration Inc., Nashua, NH (US)

(72) Inventors: Kenneth P. Cogan, Cedar Rapids, IA (US); Sean L. Heitz, Blue Grass, IA (US); Kent A. Crockett, Marion, IA (US); Benjamin M. Graubard, Alburnett, IA (US); James K. Weighton, Central City, IA (US); Jimmey C. Stultz, Virginia Beach, VA (US); Wayne D. Tattershall, Cedar Rapids, IA (US); David R. Smith, Seattle, WA (US); Matt McElvogue, Vashon, WA (US); Warren D. Schramm, Seattle, WA (US)

(73) Assignee: BAE Systems Information and Electronic Systems Integration Inc, Nashua, NH (US)

(21) Appl. No.: 18/322,325

(22) Filed: May 23, 2023

(51) Int. Cl. G06F 3/14; G01C 21/36; G06F 3/02; G06T 11/60

(52) U.S. Cl. CPC G06F 3/14; G01C 21/3664; G06F 3/0202; G06T 11/60

(57) ABSTRACT

A navigation device includes a display, an electromagnetic radiation (EMR) receiver, and one or more processors operatively coupled to the display and the EMR receiver. The one or more processors are configured to cause the display, in a first mode of operation, to graphically render a navigation view. The navigation view includes (i) a first informational element relating to a geographic location of the navigation device and (ii) one or both of a compass rose and a geographic map. The one or more processors are further configured to cause the display, in a second mode of operation and responsive to receiving an EMR signal via the EMR receiver, to render an informational view including a second informational element, where the informational view at least partially obscures the navigation view.

### STATEMENT OF GOVERNMENT INTEREST

This invention was made with government support under prime contract number OTA 19 01C 001 awarded by the United States Space Force. The government has certain rights in the invention.

### FIELD OF DISCLOSURE

The present disclosure relates to navigation systems, and more particularly, to portable, handheld navigation devices.

### BACKGROUND

A navigation device can be used to calculate a geographical position of the device and to assist a user with route planning. For example, the device can use a global navigation satellite system (GNSS), such as the Global Positioning System (GPS), and/or other navigational aids to obtain location information and to use that information in conjunction with map data to plot the position of the device on a map or to otherwise provide the geographical location of the device to the user.

### BRIEF DESCRIPTION OF THE DRAWINGS

FIG. 1 is a block diagram of a navigation device, in accordance with an example of the present disclosure.

FIG. 2 is a front pictorial view of the navigation device, in accordance with an example of the present disclosure.

FIG. 3 shows several elements of a graphical user interface (GUI) of the navigation device, in accordance with examples of the present disclosure.

FIG. 4 shows a compass view display of the GUI of FIG. 3, in accordance with an example of the present disclosure.

FIG. 5 shows a map view display of the GUI of FIG. 3, in accordance with an example of the present disclosure.

FIGS. 6A, 6B, and 7 show modal overlay displays of the GUI of FIG. 3, in accordance with examples of the present disclosure.

FIGS. 8-18 show a route creation flow, in accordance with an example of the present disclosure.

FIGS. 19-25 show a route navigation flow, in accordance with an example of the present disclosure.

FIGS. 26-31 show a signal jamming flow, in accordance with an example of the present disclosure.

FIGS. 32-36 show a review track flow, in accordance with an example of the present disclosure.

FIGS. 37-46 show a transfer mission overlay flow, in accordance with an example of the present disclosure.

FIGS. 47A-B are front and rear perspective pictorial views of the device in a wrist-worn configuration, in accordance with an example of the present disclosure.

FIG. 47C is a front pictorial view of the device of FIGS. 47A-B, in accordance with an example of the present disclosure.

FIG. 48 is a flow diagram of a method for operating a navigation device, in accordance with an example of the present disclosure.

Although the following detailed description will proceed with reference being made to illustrative examples, many alternatives, modifications, and variations thereof will be apparent in light of this disclosure.

### DETAILED DESCRIPTION

A navigation device is described. Although the device can be used in any number of applications, it is particularly useful to military applications for use by soldiers in carrying out a given mission. In an example, the device includes a display, an electromagnetic radiation (EMR) receiver, and one or more processors operatively coupled to the display and the EMR receiver. The one or more processors are configured to cause the display, in a first mode of operation, to graphically render a navigation view. The navigation view includes (i) a first informational element relating to a geographic location of the navigation device and (ii) one or both of a compass rose and a geographic map. The one or more processors are further configured to cause the display, in a second mode of operation and responsive to receiving an EMR signal via the EMR receiver (e.g., such as a GPS signal or position calculated from the GPS signal), to render an informational view including a second informational element, where the informational view at least partially obscures the navigation view. In some such examples, the informational view persists until acknowledged or dismissed by a user (e.g., via a hardware switch). The informational view can have various forms. For example, the informational view may include message alerts which include text that provides further details about the nature of the alert, or list alerts which include one or more data fields that provide additional data (e.g., geographic coordinates, clocks, timers, time stamps, waypoint or marker names, satellite status data, calculation or data transfer progress indicators, azimuth, elevation, and/or other data). The device is contained in a housing that includes several physical switches or buttons. The switches can be used individually or in various combinations to activate certain functions of the device. Numerous variations will be appreciated in light of this disclosure.

### Hardware Overview

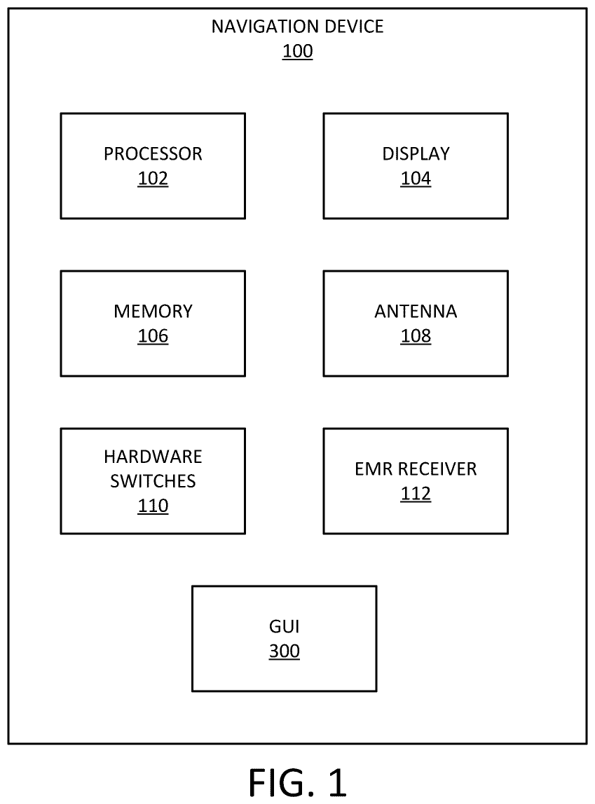

FIG. 1 is a block diagram of a navigation device 100, in accordance with an example of the present disclosure. The device 100 includes one or more processors 102, a display 104, a memory 106, one or more antennas 108, one or more hardware switches 110, an electromagnetic radiation (EMR) receiver 112, and a graphical user interface (GUI) 300. The processor(s) 102 are configured to perform various processes for controlling the device, such as described in further detail below. Such processes include, for example, displaying information and at least portions of the GUI 300 on the display 104, processing EMR signals received by the antenna 108 via the EMR receiver 112, receiving signals from the hardware switches 110, and storing and retrieving data to and from the memory 106. As shown, code for the GUI may be stored, for example, in memory 106 (or other storage of device 100 accessible to the processor(s) 102). The processor(s) 102 may access and execute that GUI code thereby causing display of the GUI on display 104 and allowing a user to interact with and otherwise use device 100.

In some examples, the device 100 is a GPS- or GNSS-based navigation device, where the EMR signals include GPS signals or other GNSS signals, including M-CODE encrypted GNSS (e.g., for anti-jamming and secure access of military GPS signals). In such examples, the GUI can be tailored specifically to the needs of users for land navigation in combat environments. For instance, the GUI can be designed to support soldiers in completing their mission by providing secure, accurate navigation information, in a concise format and allowing them to move efficiently while maintaining situational awareness of their environment. In other examples, the GUI can be configured for commercial or other consumer uses, such as where the device 100 is used for navigation while driving, walking/hiking, sailing, or flying. Features and information of the device 100 are prioritized and organized within the GUI so the user is able to quickly comprehend the design and achieve goals (e.g., land navigation) with a simple and easy-to-use interface. To this end, certain features of the device 100 are specifically configured to facilitate these objectives, as variously described herein.

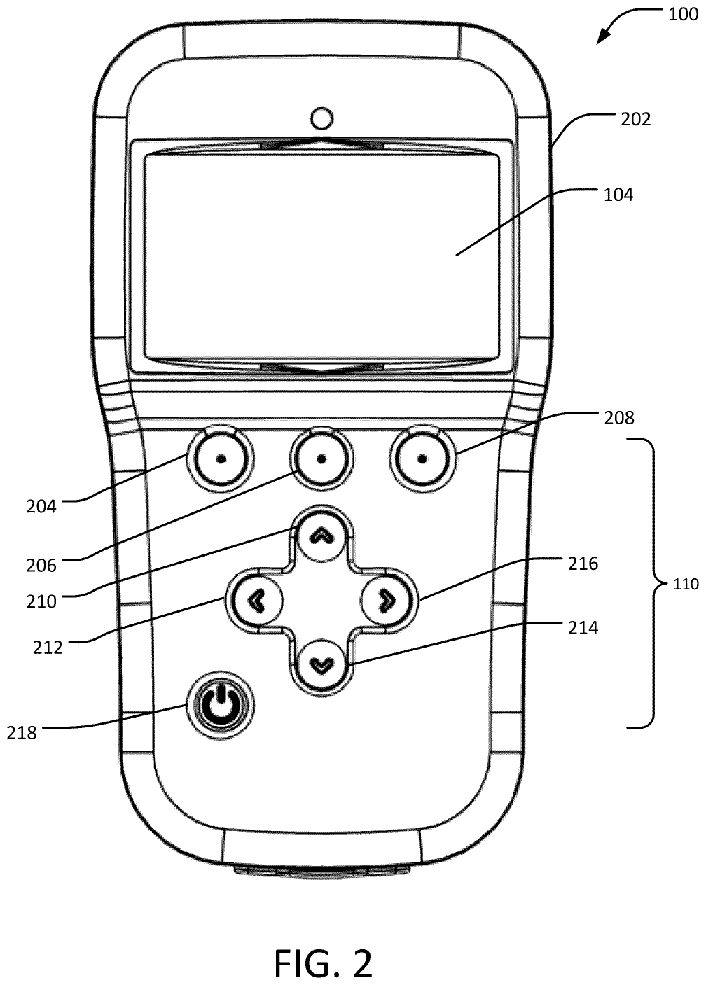

FIG. 2 is a front pictorial view of the device 100, in accordance with an example of the present disclosure. The device 100 is portable and handheld in this example, but may also be donned by the user in a glanceable position (e.g., on user's arm or chest) to reduce loss to operational momentum and maintaining situational awareness. The device 100 includes the display 104 and the hardware switches 110 each mounted on or in a case 202. The hardware switches 110 can be, for example, separate depressible buttons and include a left hardware switch 204, a center hardware switch 206, a right hardware switch 208, an up direction switch 210, a left direction switch 212, a down direction switch 214, a right direction switch 216, and a power switch 218. The left, center, and right hardware switches 204, 206, and 208 are positioned adjacent to the display 104. As will be discussed in further detail below, the GUI is configured to assign functions to the hardware switches 110 using labels on the display 104. The labels indicate the function corresponding to each of the switches. For example, the display 104 can show a first label adjacent to the left hardware switch 204, a second label adjacent to the center hardware switch 206, and a third label adjacent to the right hardware switch 208. As such, the functions of the hardware switches 110 can be varied in software according to the state of operation of the device 100, and the labels in the GUI indicate to the user the present function of each switch each the respective state of operation. Such tactile switches 110 may be advantageous to certain users, such as soldiers, who may dislike or otherwise not be able to effectively use a touch screen display (e.g., due to use of non-conductive gloves) or a stylus-based input mechanism (e.g., a stowable stylus is easy to lose).

### Graphical User Interface

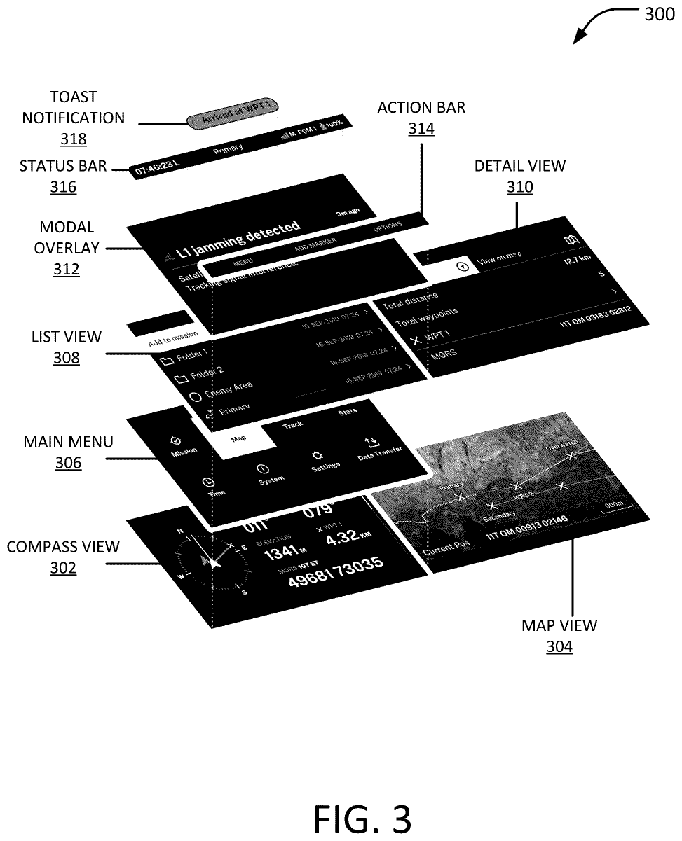

FIGS. 3-7 show a graphical user interface (GUI) 300 for the device 100, in accordance with examples of the present disclosure. The device 100 is configured to display the GUI 300 via the display 104. The GUI 300 is designed to provide secure, accurate navigation information. The features and information provided to a user by the device 100 are prioritized and organized so the user is able to quickly comprehend the GUI 300 and perform geographic navigation.

The GUI 300 is configured to provide quick access to the core views with a simple information architecture, redundant paths to key features, and button combinations for frequent commands. The navigation view, which includes a compass view and/or a map view, is accessible at all times from anywhere in the system via one or more user inputs via the hardware switches 110 of the device. This ensures that the user can easily access the navigation view to obtain directions and current mission information.

FIG. 3 shows several elements of the GUI 300, in accordance with examples of the present disclosure. The GUI 300 includes a compass view display 302, a map view display 304, a main menu display 306, a list view display 308, a detail view display 310, a modal overlay display 312, an action bar 314, a status bar 316, and a toast notification 318. The compass view display 302 and the map view display 304 are complementary displays that provide navigational information to the user. The main menu display 306 is a central location for accessing various information and functions of the device 100. The list view display 308 and the detail view display 310 are complementary displays that provide entry and retrieval of information related to specific features of the device 100, such as position and movement information, track and route information, waypoint and marker information, and other data stored in the memory 106 of the device 100.

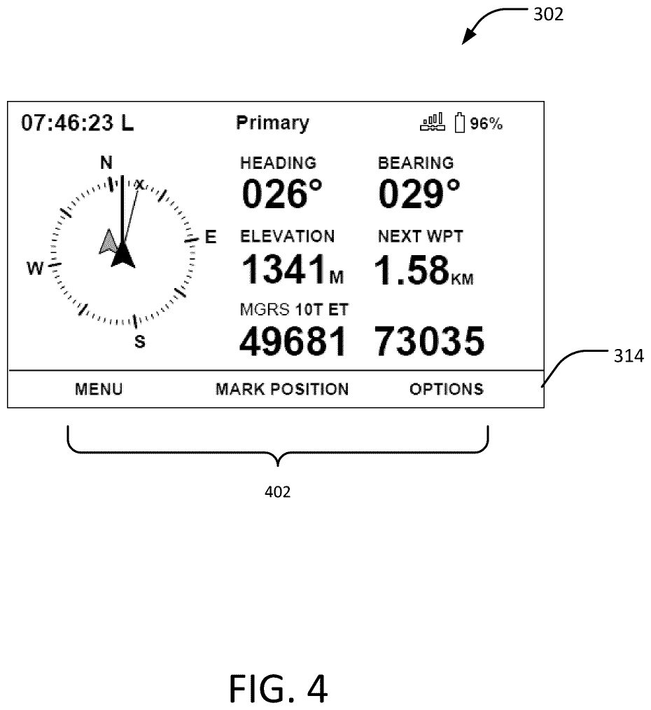

FIG. 4 shows the compass view display 302, in accordance with an example of the present disclosure. The compass view display 302 includes navigational information such as the current location of the device, cardinal directions with respect to the device, and a bearing to a waypoint, marker, destination, or other point of interest. For example, the compass view display 302 can include a compass rose, a heading indicator, a bearing indicator, and navigational data such as heading in degrees, bearing in degrees, elevation in meters, distance to the next waypoint in kilometers, and geographical coordinates (e.g., in military grid reference system (MGRS) or latitude/longitude). The action bar display 314 can be superimposed over a portion of the compass view display 302. The action bar display 314 includes variable labels 402 that correspond with features or functions that can be activated by pressing the corresponding hardware switches 110 of the device 100. For example, in the configuration shown in FIG. 4, the left hardware switch 204 can activate the main menu display 306, the center hardware switch 206 can activate a ‘mark position’ function, and the right hardware switch 208 can activate an options menu. The labels 402 on the action bar display 314 can be changed to correspond with various other functions. The compass view display 302 can be set as the primary view for land navigation. The user can configure the waypoints, markers, destination, or other points of interest, such as described in further detail below.

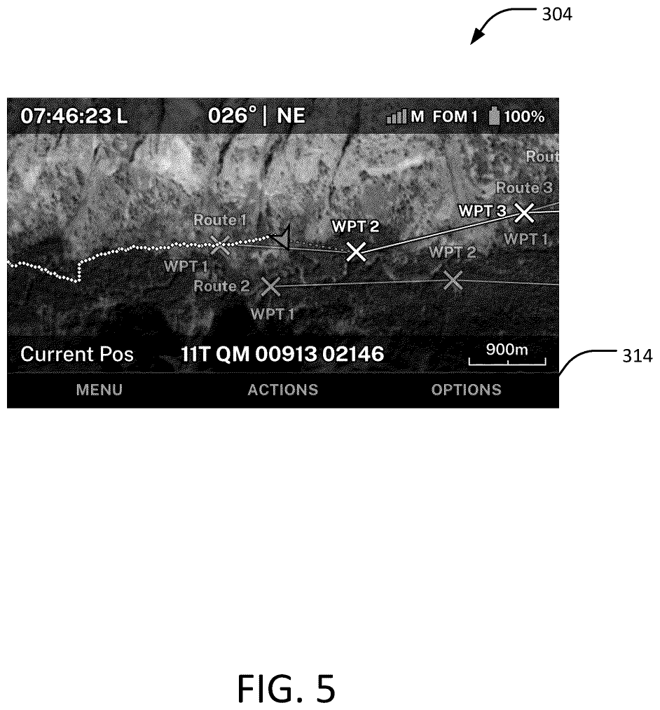

FIG. 5 shows the map view display 304, in accordance with an example of the present disclosure. The map view display 304 provides high-definition, color maps of a region that may include the current position of the device 100, one or more waypoints or markers, or other areas or geographic regions. The map view display 304 can further provide navigational information such as heading, time, map scale, and geographic coordinates. The map view display 304 facilitates situational awareness by providing additional visual references beyond those provided by the compass view display 302, such as geographic features (e.g., rivers, mountains, roads, etc.) overlaid by icons representing current position, waypoints, routes, and other navigational aids. The overlaid icons, which can be labeled with textual identifiers and/or color coded, correspond to information stored and organized according to a mission or a trip plan established by the user. Position and movement information is captured and stored in real-time as tracks, providing the user with detailed data for post-mission evaluation and intelligence gathering. Tracks can be stored as map overlays for future use or reference.

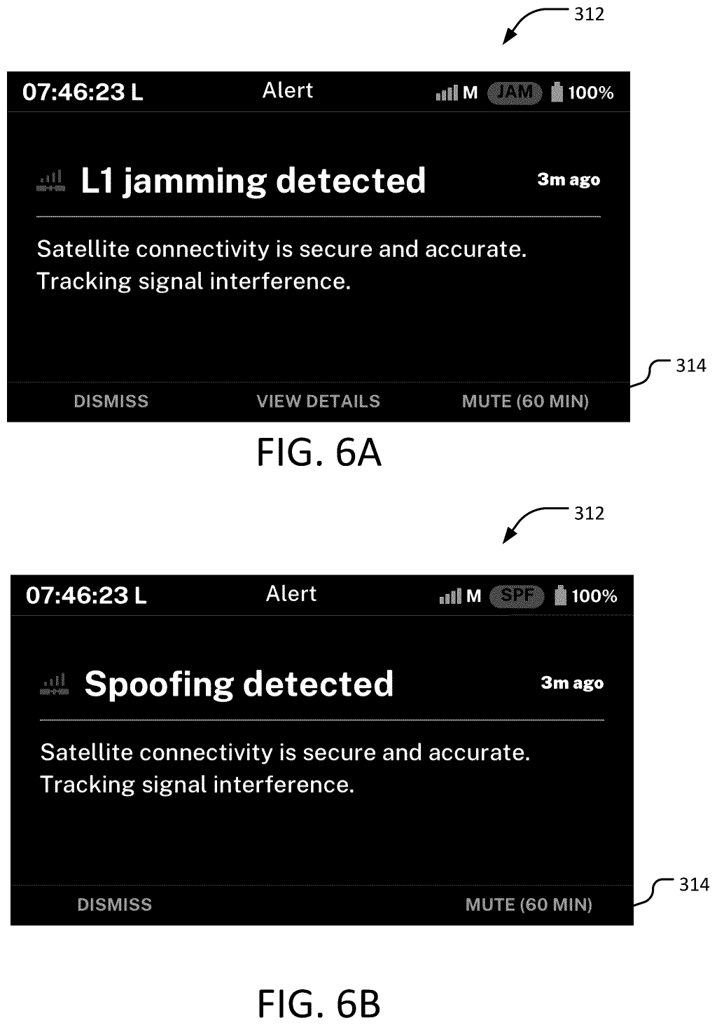

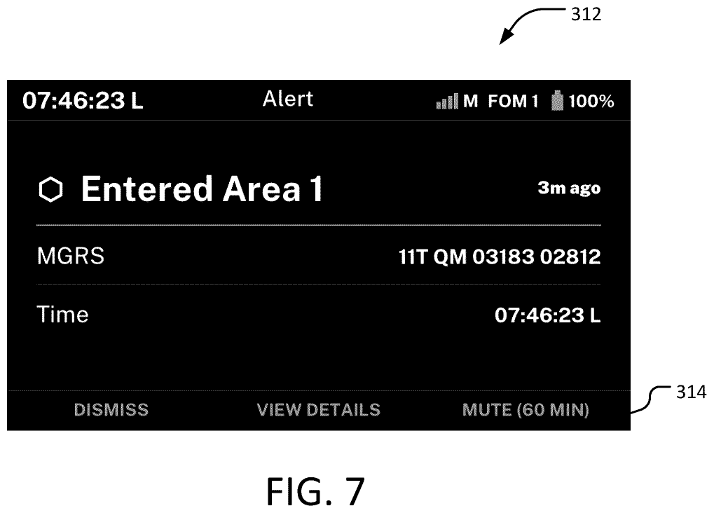

FIGS. 6A, 6B, and 7 show modal overlay displays 312, in accordance with examples of the present disclosure. The modal overlay displays 312 are pop-up displays that at least partially obscure other information displayed on the device 100, such as the compass view display 302 and the map view display 304. The modal overlay displays 312 provide certain time-sensitive information to the user, such as alerts or navigational information. For example, in a first mode of operation, the device 100 can be configured to graphically render a navigation view, such as the compass view display 302 or the map view display 304. The navigation view can include a first informational element relating to a geographic location of the navigation device, such as the heading, the bearing, the elevation, the distance to the next waypoint, and/or the geographical coordinates. The navigation view can further include a compass rose (e.g., in the compass view display) and/or a geographic map (e.g., in the map view display 304), such as shown in FIGS. 4 and 5, respectively.

Further to this example, in a second mode of operation and responsive to receiving an EMR signal via the EMR receiver 112, the device 100 can be configured to cause the display 104 to render an informational view including a second informational element, the informational view at least partially obscuring the navigation view. The informational view includes the modal overlay display 312 that automatically displays over the navigation view in response to a triggering event, such as a GPS signal or position calculated from the GPS signal, until an action is taken by the user to acknowledge or otherwise dismiss the informational view via one or more of the hardware switches 110.

The informational view can have various forms. For example, the informational view can include message alerts, which have text that provides further details about the nature of the alert, or list alerts, which have one or more data fields that provide additional data (e.g., geographic coordinates, clocks, timers, time stamps, waypoint or marker names, satellite status data, calculation or data transfer progress indicators, azimuth, elevation, and/or other data).

For example, FIGS. 6A-B each show a first informational view including information that the device has detected that the EMR signal is being jammed (FIG. 6A), spoofed (FIG. 6B), or otherwise subject to interference. In such an example, the device 100 can be configured to detect a GPS jamming or spoofing signal by failing to receive an expected GPS signal or receiving a GPS signal that cannot be validated. The first informational view is automatically displayed in response to detecting the jamming, spoofing, or other interference. Such information is useful to the user because it indicates that the operation of the device 100 may be impaired or altered by external influences, and that the security and accuracy of the information may be compromised.

In another example, FIG. 7 shows a second informational view including information that the device has entered a pre-defined geographic region as defined by geographic coordinates such as a waypoint, marker, geographic boundary, or positional phase line programmed into the device. The second informational view is automatically displayed in response to detecting that the current position of the device 100 is within the pre-defined geographic region. Such information is useful to the user because it indicates that the user has reached a navigational milestone.

The first and second informational views can each include the action bar 314 that indicates to the user the functions assigned to the hardware switches 110 of the device 100. For example, one of the labels can be ‘dismiss’ which when the user presses the left hardware switch 204 causes the informational view to be removed from the display 104, returning to the navigational view. Another one of the labels can be ‘view details’ which when the user presses the center hardware switch 206 causes the informational view to change to the detail view display, which provides additional information related to the modal overlay display. Yet another one of the labels can be ‘mute’ which when the user presses the right hardware switch 208 causes the informational view to temporarily disappear for a pre-determined amount of time (e.g., 60 minutes). Other examples of actions will be apparent. In at least some of these examples, pressing at least one of the hardware switches 110 causes the device 100 to return to the first mode of operation, where the device graphically renders the navigation view (e.g., the compass view display 302 and/or the map view display 304).

### Usage Flows

The GUI 300, according to some examples, incorporates various usage flows. A usage flow, or simply a given flow, is a sequence of operations that define how various functions and operations of the device can be utilized by the user. For example, the compass view display 302 and/or map view display 304 are at a first or base level of certain flows. The main menu display 306 is at a second level, and the list view display 308 and the detail view display 310 are at a third level. The user can access the second level (e.g., the main menu) from the base level and access the third level (e.g., the list view display and the detail view display) from the second level. The base level can be directly accessed from any other level. For example, at any point in the flow the user can return to the compass view display 302 or map view display 304 by a single press of one of the hardware switches 110. Similarly, when alerts or notifications are triggered, the modal overlay displays 312 as the foremost element on the screen until action is taken by the user. The action bar 314 indicates what actions the user may take at a given point in the flow. The status bar 316 is visible with information displayed at all times no matter the view. The toast notifications 318 float temporarily over the center of the status bar 316, alerting users with information relevant to the mission, such as position, velocity, and precise time (PVT) assurance, cryptography key status, connected systems, power and battery percentage, and current time.

In a military context, visual elements added to a map are known as overlays. Each overlay is comprised of coordinates which define one or more desired locations (e.g., a route waypoint or a point of interest). The overlays and corresponding coordinates are created and edited through task-oriented modes. For example, the user can create a route and navigate a route using flows as described below. Other flows can be used to perform other functions, such as alerting the user to signal jamming, reviewing a track, and transferring mission data, as further described below.

For example, a position, navigation, and timing (PNT) mission can include several phases, including pre-mission planning, on-mission navigation, and post-mission debriefing. During pre-mission planning, a variety of tools and processes are used to plan mounted and/or dismounted missions. These tools include digital planning software, maps, orders and operation outlines, and land navigation devices. During post-mission debriefing soldiers engage in intelligence gathering in a number of ways, such as reviewing tracks. To these ends, the device 100 is configured to prioritize quick access to the current location, the distance and direction to the next waypoint, detailed color maps, points-of-interest relevant to the current mission, and quick marking of positions.

The hardware switches 110 are designed to maximize the usability, accessibility, and efficiency of interacting with the device 100. For example, the device 100 provides shortcut combinations of the hardware switches 100 for quick access to critical information and features, such as, marking position or quickly returning to the compass view from anywhere in the interface. The hardware switch combination mappings are designed to build upon the mental model of the GUI 300. For example, closing the menu occurs on the same side and involves the same button as opening the menu; changing the brightness utilizes up and down; opening settings occurs on the same side as settings in the menu; and the same button is used to access options. Such switch combinations can remain active even when individual buttons are not in use on the current screen state. For example, quick back is available from any screen state and returns the view to either the compass view display 302 or the map view display 304, depending on which was last viewed. While in the map view display 304, a position toggle returns the map to the current location. If the map is already on the current location, the position toggle toggles heading up or north up map views depending on which is the current selection. While in the map view display 304, a directional button short press pans the viewport in small increments, a directional button long press pans the viewport in large increments. Other variations will be apparent.

### Route Creation Flow

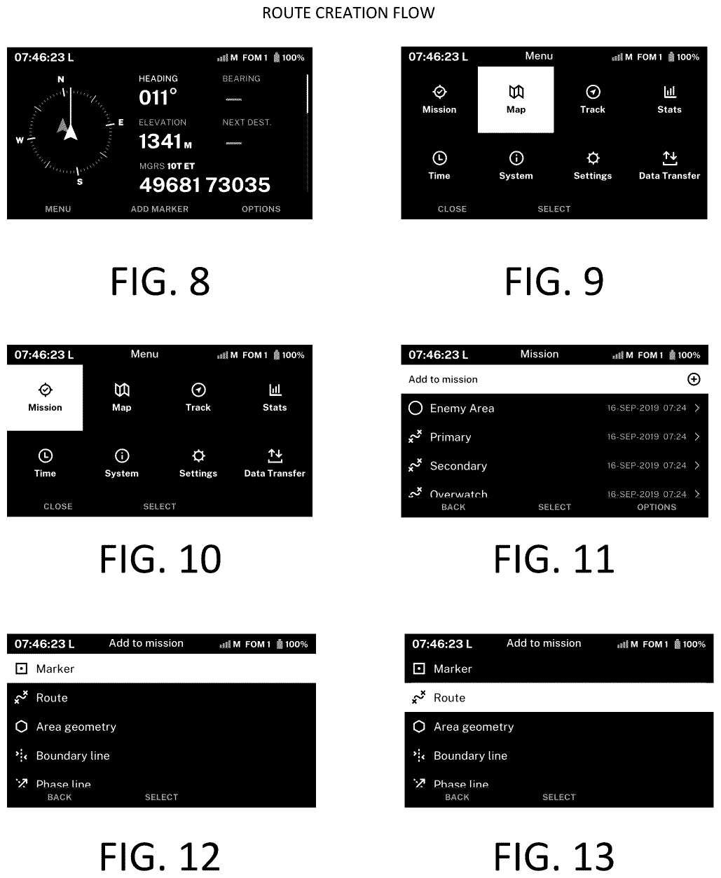

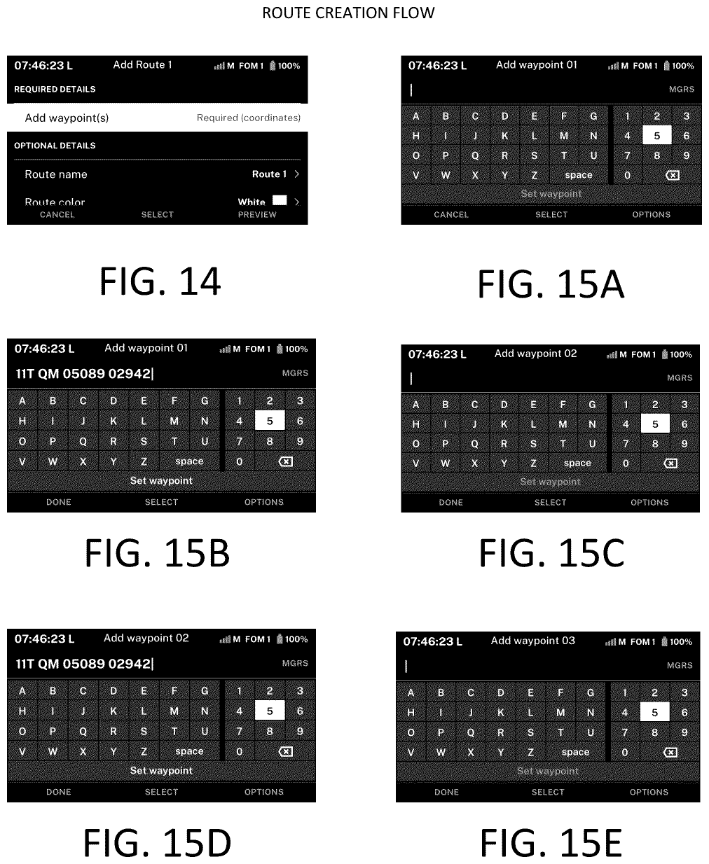

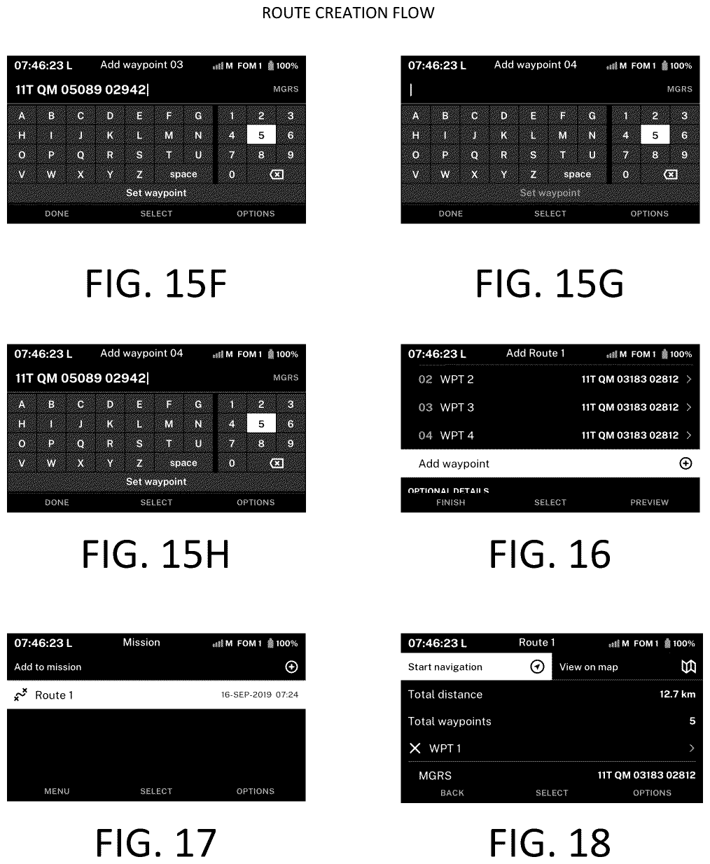

FIGS. 8-18 show a route creation flow, in accordance with an example of the present disclosure. FIG. 8 shows a compass view display 302 of the GUI, with an action ‘menu’ label assigned to the left hardware switch 204. Pressing the left hardware switch 204 from the compass view display 302 brings up the main menu display 306 as shown in FIG. 9. In FIG. 9, pressing the left direction switch 212 causes the highlighted icon to scroll to the left from ‘map’ to ‘mission’ as shown in FIG. 10. Pressing the center hardware switch 206 from the main menu display 306 brings up the ‘mission’ list display as shown in FIG. 11. Pressing the center hardware switch 206 selects ‘add to mission’ and brings up the ‘add to mission’ display as shown in FIG. 12. Pressing the down direction switch 214 selects ‘route’ as shown in FIG. 13. Pressing the center hardware switch 206 selects ‘route’ and brings up ‘add route 1’ as shown in FIG. 14. Pressing the center hardware switch 206 selects ‘add waypoint(s)’ and brings up ‘add waypoint 01’ as shown in FIG. 15A.

FIGS. 15B-H show a sequence of displays where the user enters multiple waypoints. Referring to FIG. 15H, pressing the left hardware switch 204 selects ‘done’ to complete the adding of waypoints and brings up the ‘add route 1’ display as shown in FIG. 16. Pressing the center hardware switch 206 brings up the ‘mission’ list display and highlights the newly created route ‘Route 1’ as shown in FIG. 17. Again pressing the center hardware switch 206 selects the route and brings up the ‘route 1’ display as shown in FIG. 18, which ends the route creation flow.

### Route Navigation Flow

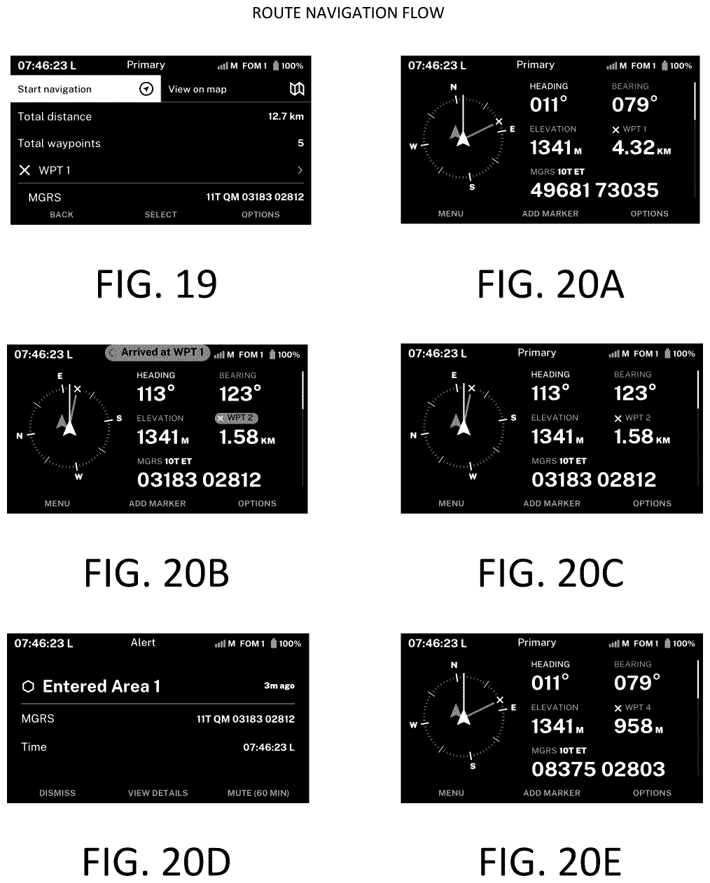

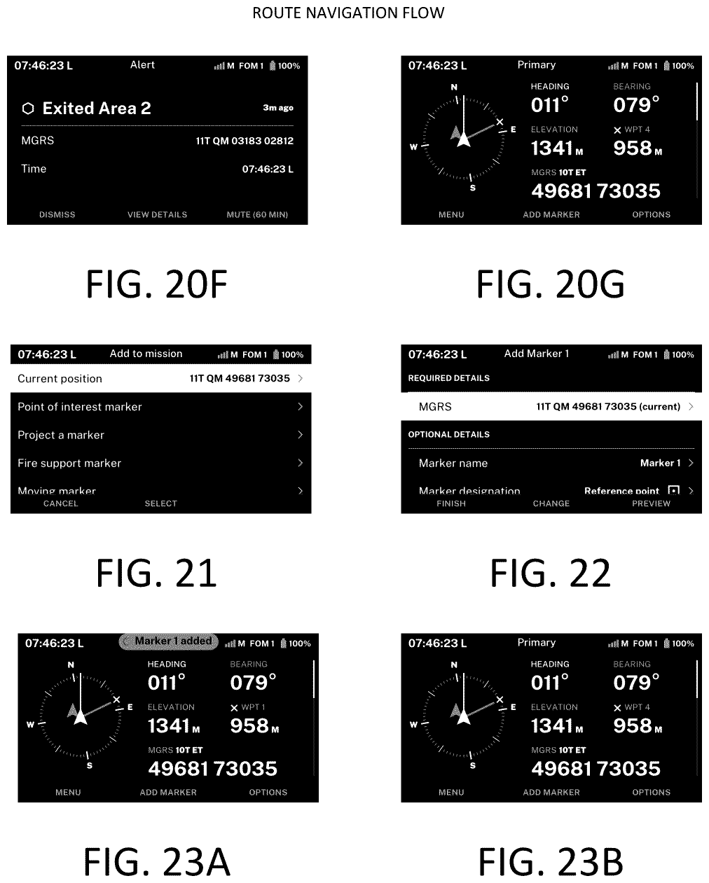

FIGS. 19-25 show a route navigation flow, in accordance with an example of the present disclosure. FIG. 19 shows a route navigation view display of the GUI, with an action ‘select’ label assigned to the center hardware switch 206. Pressing the center hardware switch 206 from the route navigation view display starts the navigation flow and brings up the compass view display 302 as shown in FIG. 20A. Upon arrival at a first waypoint a toast notification ‘arrived at WPT1’ is overlaid on the compass view display 302 as shown in FIG. 20B to alert the user of the arrival. Upon continuing to navigate, a distance to a second waypoint is shown in the compass view display 302 as shown in FIG. 20A. Upon continuing to navigate toward a first region ‘Area 1’ the compass view display 302 continues as shown in FIG. 20C. Upon entering the first region a modal overlay display for entering the first region is overlaid on the compass view display 302 as shown in FIG. 20D, with an action ‘dismiss’ label assigned to the left hardware switch 204. Pressing the left hardware switch 204 from the modal overlay display dismisses the modal overlay display and returns to the compass view display 302 as shown in FIG. 20E. Upon exiting a second region ‘Area 2’ a modal overlay display for exiting the second region is overlaid on the compass view display 302 as shown in FIG. 20F, with an action ‘dismiss’ label assigned to the left hardware switch 204. Pressing the left hardware switch 204 from the modal overlay display dismisses the modal overlay display and returns to the compass view display 302 as shown in FIG. 20G.

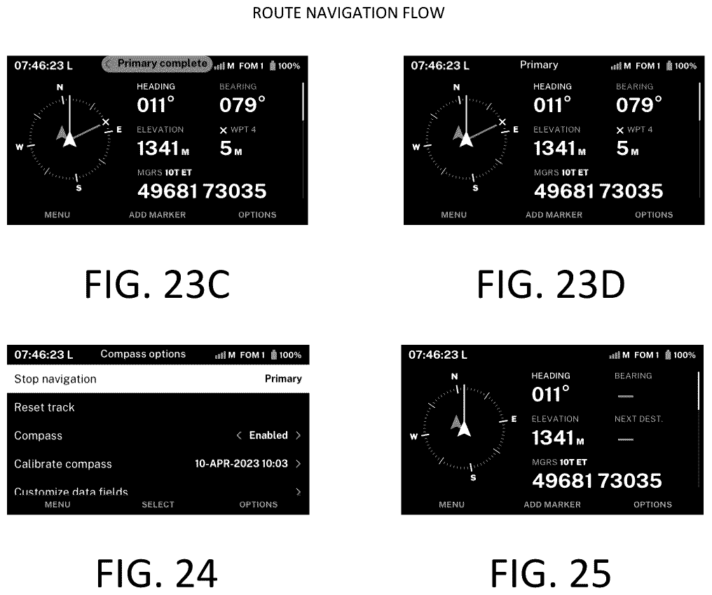

In the compass view display 302 of FIG. 20G, an action ‘add marker’ label is assigned to the center hardware switch 206. Pressing the center hardware switch 206 from the compass view display 302 brings up a ‘mark position’ display as shown in FIG. 21 with an action ‘select—current position’ label assigned to the center hardware switch 206. Pressing the center hardware switch 206 brings up an ‘add Marker 1’ display as shown in FIG. 22 with an action ‘finish’ label assigned to the left hardware switch 204. Pressing the left hardware switch 204 brings up the compass view display 302 with a toast notification ‘Marker 1 added’ as shown in FIG. 23A. Continuing to navigate causes the toast notification to be removed from the compass view display 302 as shown in FIG. 23B. Upon arriving at the end of the route, a toast notification ‘primary complete’ is displayed as shown in FIG. 23C. Upon arriving at a waypoint ‘WPT4’ the compass view display 302 is as shown in FIG. 23D with an action ‘menu’ label assigned to the left hardware switch 204. Pressing the left hardware switch 204 brings up a ‘compass options’ display as shown in FIG. 24 with an action ‘select—stop navigation’ label assigned to the center hardware switch 206. Pressing the center hardware switch 206 completes the route navigation flow and brings up the compass view display 302 as shown in FIG. 25.

### Signal Jamming Flow

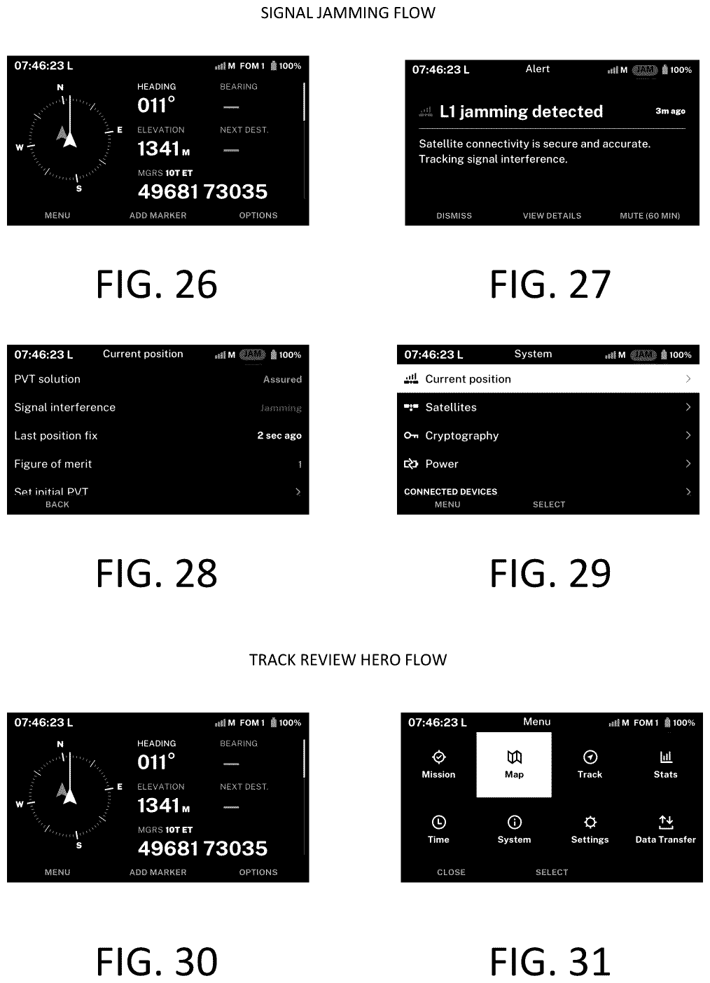

FIGS. 26-29 show a signal jamming flow, in accordance with an example of the present disclosure. FIG. 26 shows a compass view display 302 of the GUI. Upon encountering signal interference, a modal overlay display is presented with an action ‘view details’ label assigned to the center hardware switch 206 as shown in FIG. 27. Pressing the center hardware switch 206 brings up a ‘current position’ display with an action ‘back’ label assigned to the left hardware switch 204 as shown in FIG. 28. Pressing the left hardware switch 204 brings up a ‘system’ display as shown ion FIG. 29, completing the signal jamming flow.

### Review Track Flow

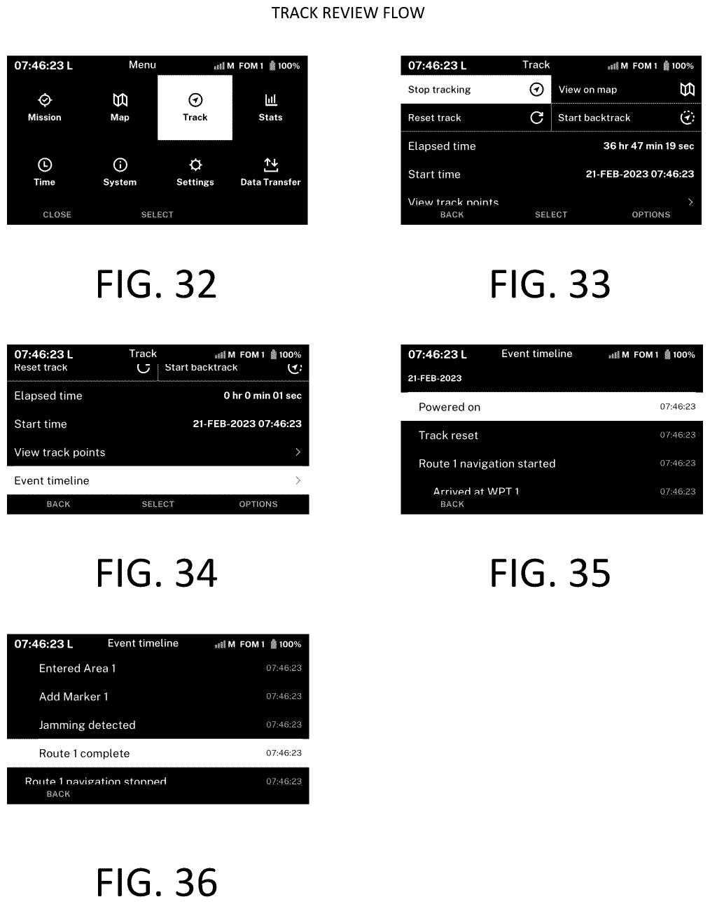

FIGS. 30-42 show a review track flow, in accordance with an example of the present disclosure. FIG. 30 shows a compass view display 302 of the GUI, with an action ‘menu’ label assigned to the left hardware switch 204. Pressing the left hardware switch 204 from the compass view display 302 brings up the main menu display 306 as shown in FIG. 31. In FIG. 31, pressing the right direction switch 216 causes the highlighted icon to scroll to the right from ‘map’ to ‘track’ as shown in FIG. 32. Pressing the center hardware switch 206 from the main menu display 306 brings up the ‘track’ list display as shown in FIG. 33. Pressing the down direction switch 214 from the ‘track’ list display scrolls down to an action ‘select—event timeline’ label assigned to the center hardware switch 206 as shown in FIG. 34. Pressing the center hardware switch 206 brings up an ‘event timeline’ display as shown in FIG. 35. Pressing the down direction switch 214 from the ‘event timeline’ display scrolls down to an action ‘select—Route 1 complete’ label assigned to the center hardware switch 206 as shown in FIG. 36.

### Transfer Mission Overlay Flow

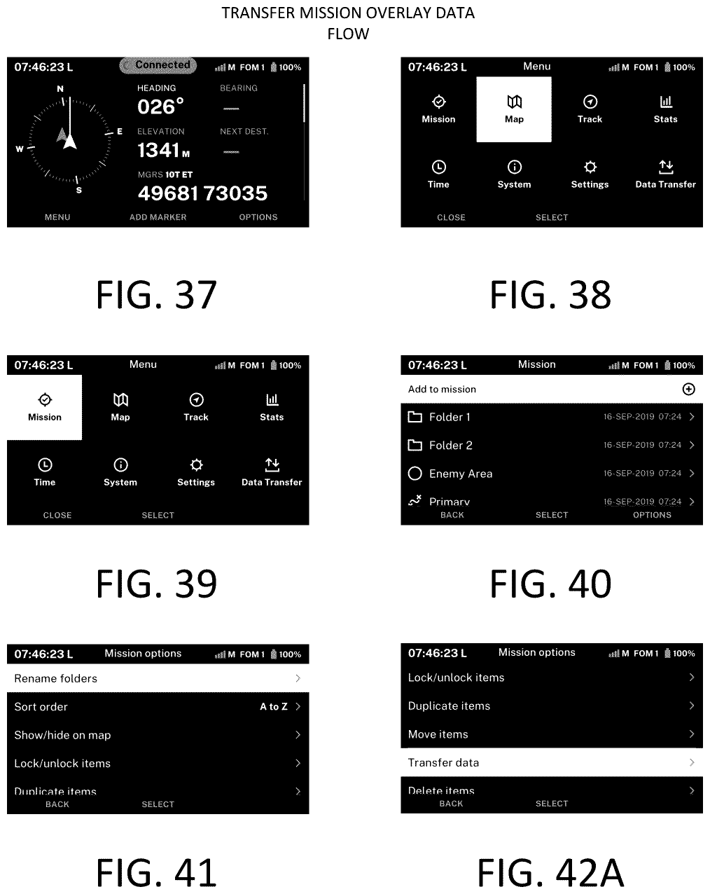

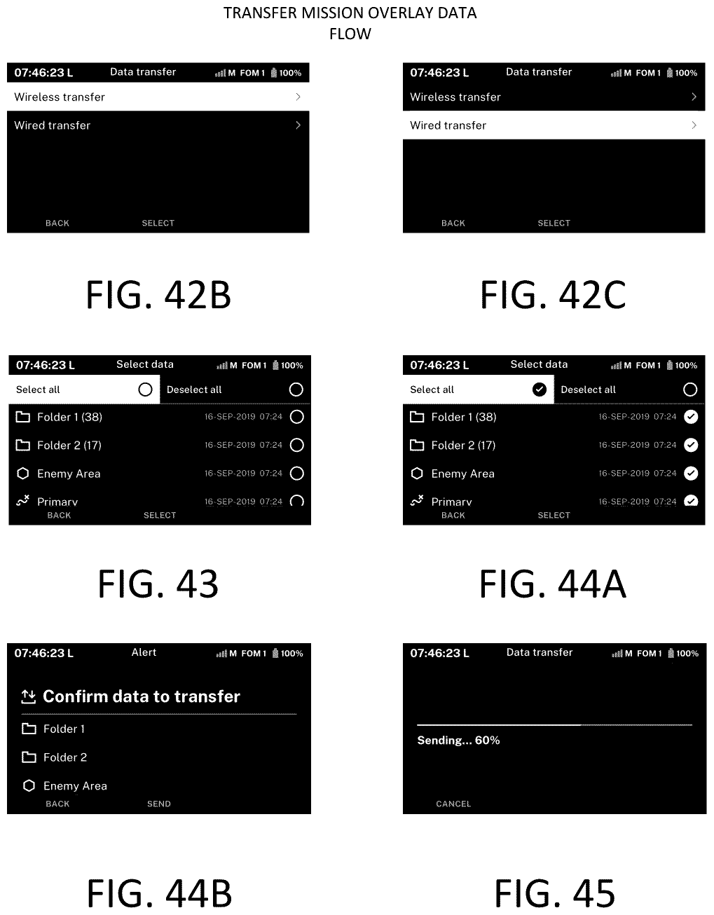

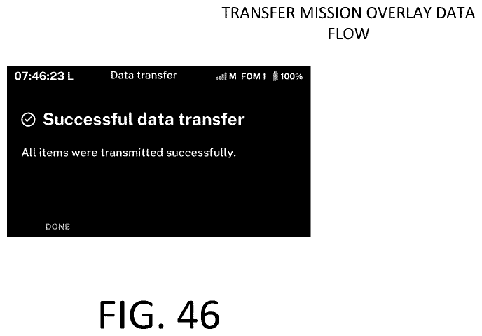

FIGS. 37-46 show a transfer mission overlay flow, in accordance with an example of the present disclosure. Upon connecting the device to a personal computer or another handheld navigation device, a ‘connected’ toast notification is displayed over the compass view display 302 as shown in FIG. 37. Pressing the left hardware switch 204 from the compass view display 302 brings up the main menu display 306 as shown in FIG. 38. In FIG. 38, pressing the left direction switch 212 causes the highlighted icon to scroll to the left from ‘map’ to ‘mission’ as shown in FIG. 39. Pressing the center hardware switch 206 from the main menu display 306 brings up the ‘mission’ list display with an action ‘options’ label assigned to the right hardware switch as shown in FIG. 40. Pressing the right hardware switch brings up a ‘mission options’ list view display as shown in FIG. 41. Pressing the down direction switch 214 scrolls down to an action ‘select—transfer data’ label assigned to the center hardware switch 206 as shown in FIG. 42A. Pressing the center hardware switch 206 brings up a ‘Data transfer’ list display with an action ‘select—wireless transfer’ label assigned to the center hardware switch 206 as shown in FIG. 42B. Pressing the down direction switch 214 changes the action to ‘select—wired transfer’ label assigned to the center hardware switch 206 as shown in FIG. 42C. Pressing the center hardware switch 206 brings up a ‘select items to send’ list display with an action ‘select all’ label assigned to the center hardware switch 206 as shown in FIG. 43. Pressing the center hardware switch 206 selects all items in the list with an action ‘send’ label assigned to the center hardware switch 206 as shown in FIG. 44A. Pressing the center hardware switch 206 brings up a ‘confirm data to transfer’ display as shown in FIG. 44B. Pressing the center hardware switch 206 begins the data transfer process and brings up a ‘send data’ progress display as shown in FIG. 45. Upon completion of the data transfer, a ‘successful data transfer’ notification is displayed as shown in FIG. 46.

### Wrist-Worn Navigation Device

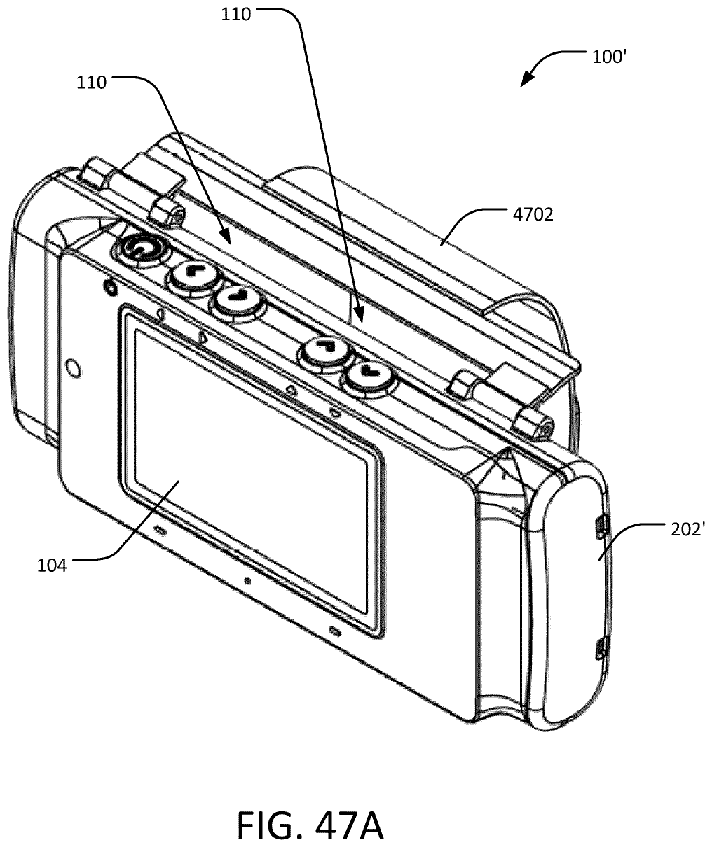

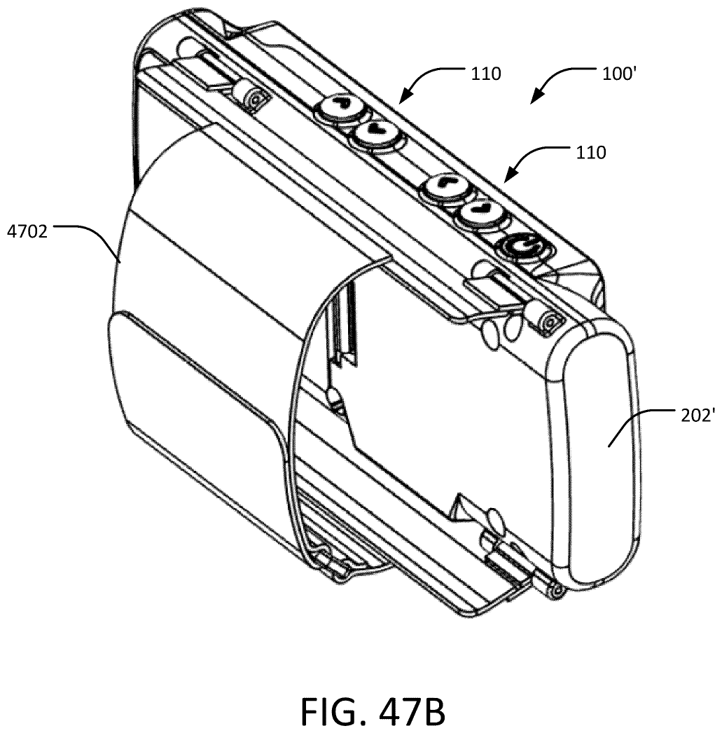

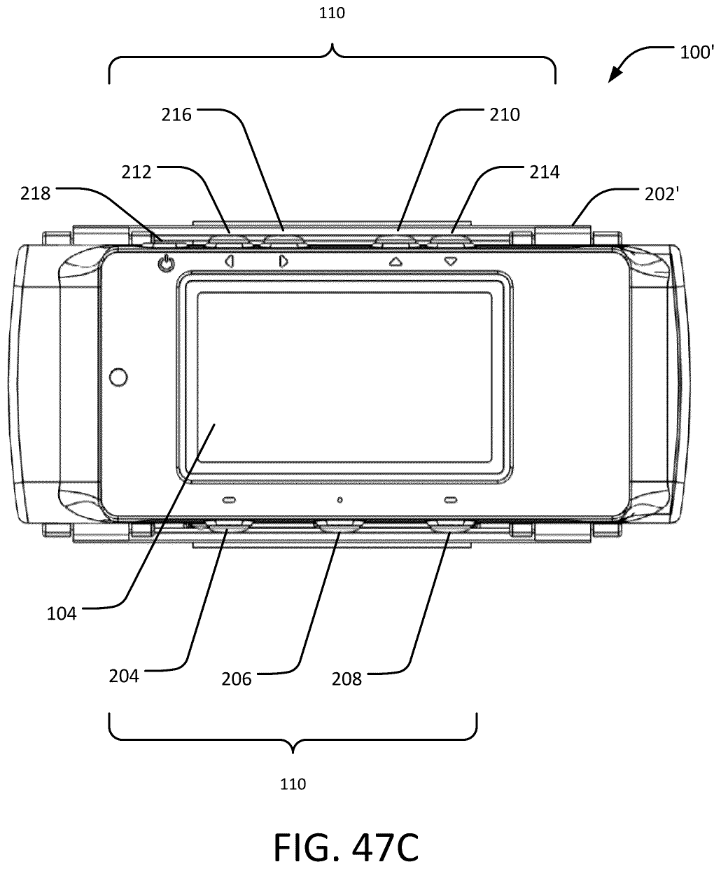

FIGS. 47A-B are front and rear perspective views of a device 100′ in a wrist-worn configuration, and FIG. 47C is a front view of the device 100′, in accordance with an example of the present disclosure. The device 100′ is similar to the device 100 of FIG. 1 and can be attached to a user's wrist via a wristband 4702 coupled to a case 202′ of the device 100′ and configured to attach the case 202′ to a wrist of a user. The device 100′ includes the display 104 and the hardware switches 110 each mounted on or in the case 202′.

### Hardware Buttons and Shortcut Combinations

Referring again to FIGS. 2 and 47C, the hardware switches 110 are designed to maximize the usability, accessibility, and efficiency of interacting with the device 100, 100′. The hardware switches 110 can be used individually or in various combinations (e.g., pressing two or more of the switches simultaneously) to control the device 100, 100′. In some examples, the hardware switches 110 are configured to provide shortcut combinations for quick access to information and features, such as marking position or quickly returning to the compass view display 302 from anywhere in the GUI 300.

For example, the left hardware switch 204 can be used to open and close the main menu display 306, and the up direction switch 210 and the down direction switch 214 can be used to change the display brightness. The hardware switches 110, and combinations thereof, remain active even while individual switches are not labeled in the GUI 300. For example, while in map view, double-pressing the right hardware switch 208 centers the map to the current location of the device 100, 100′. If the map is already centered, double-pressing the right hardware switch 208 toggles between heading up or north up map views. While in map view, short presses of one of the directional switches (e.g., the up, left, down, and right direction switches 210, 214, 216, and 216) pans the map view display in small increments, and longer presses of one of the directional switches pans the map view display in large increments. Other examples are as follows:

Continuously pressing the power switch 218 for several seconds (e.g., 3 seconds or longer) turns the power of the device 100 on or off. Briefly pressing the power switch 218 (e.g., for less than 3 seconds) places the device 100, 100′ into a sleep/hibernation mode or wakes the device 100, 100′ from the sleep/hibernation mode. The sleep/hibernation mode can, for example, include a mode of operation where the device 100, 100′ is not fully powered off but the display 104 is turned off and certain other functions, such as position tracking, are dormant.

Pressing the left hardware switch 204 and the left direction switch 212 simultaneously causes the GUI 300 to revert back to a previous state.

Pressing the center hardware switch 206 and the down direction switch 214 simultaneously causes the brightness of the display 104 to decrease.

Pressing the center hardware switch 206 and the up direction switch 210 simultaneously causes the brightness of the display 104 to increase.

Pressing the center hardware switch 206 and the right direction switch 216 simultaneously marks the current position in the route tracking.

Pressing the center hardware switch 206, the left direction switch 212, and the right direction switch 216 simultaneously initiates a so-called zeroize function, which completely clears all data stored in the device 100, 100′. For example, the zeroize function is configured to erase data from the memory 106 responsive to a user input via one or more of the hardware switches 110, such as described above. In some examples, a confirmation can be displayed before committing to the zeroize function. In some examples, continuously pressing the center hardware switch 206, the left direction switch 212, and the right direction switch 216 simultaneously for several seconds (e.g., 5 or more seconds) activates the zeroize function without further confirmation.

Pressing the right hardware switch 208 and the right direction switch 216 simultaneously brings up a quick settings menu. The quick settings menu can include, for example, a set of settings that are available regardless of the current state of operation of the device 100, 100′, such as changing display brightness, angle units of measure, locking switches (e.g., locking out certain functions initiated by switch presses), turning route tracking on or off, turning alert notifications on or off, and/or changing setting profiles.

In some examples, such as shown in the wrist-worn device 100′ of FIGS. 47A-C, the hardware switches 110 are arranged to facilitate pinch gestures where the user can press two or more of the switches 110 simultaneously using a pinch gesture to activate certain functions such as described above. For example, pressing the left hardware switch 204 and the left direction switch 212 simultaneously causes the GUI 300 to revert back to a previous state; pressing the center hardware switch 206 and the down direction switch 214 simultaneously causes the brightness of the display 104 to decrease; pressing the center hardware switch 206 and the up direction switch 210 simultaneously causes the brightness of the display 104 to increase; and pressing the center hardware switch 206 and the right direction switch 216 simultaneously marks the current position in the route tracking. Each of these switch presses can be achieved using two fingers (e.g., an index finger and a thumb) in a pinch-like gesture. For example, the left hardware switch 204 and the left direction switch 212 are each on a same side (e.g., the left side) of the display 104.

### Methodology

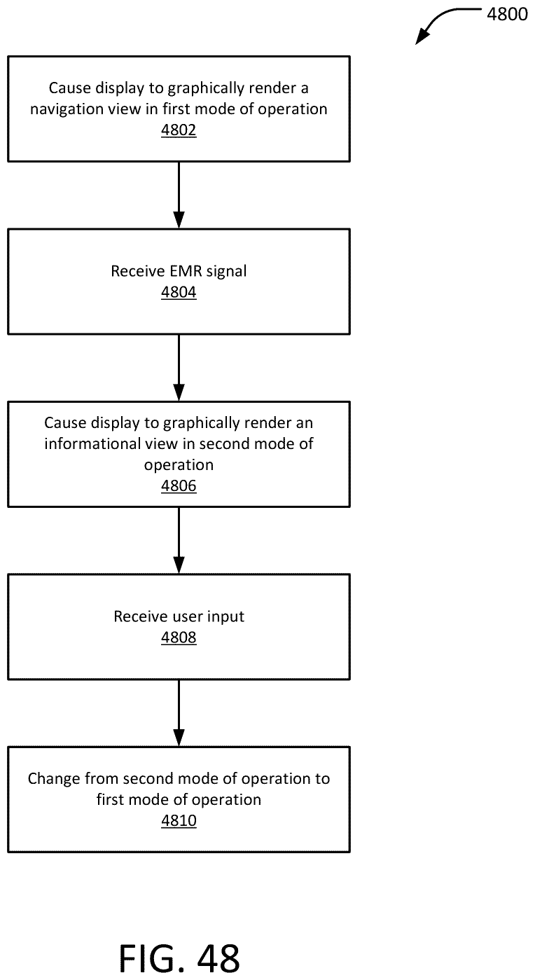

FIG. 48 is a flow diagram of a method 4800 for operating a navigation device, in accordance with an example of the present disclosure. The method 4800 can be implemented, for example, in the device 100 of FIGS. 1 and 2 and/or the device 100′ of FIGS. 47A-C. The method 4800 includes causing 4802, by one or more processors in a first mode of operation, a display to graphically render a navigation view, where the navigation view includes (i) a first informational element relating to a geographic location of the navigation device and (ii) one or both of a compass rose and a geographic map. The method 4800 further includes receiving 4804 an EMR signal via an EMR receiver and causing 4806, by the one or more processors in a second mode of operation and responsive to receiving the EMR signal, the display to render an informational view including a second informational element, the informational view at least partially obscuring the navigation view. The method 4800 further includes receiving 4808 a user input via a hardware switch of the navigation device and changing 4810, by the one or more processors, from the second mode of operation to the first mode of operation responsive to receiving the user input.

### Further Examples

The following examples pertain to further examples, from which numerous permutations and configurations will be apparent.

Example 1 provides a navigation device, comprising a display; an electromagnetic radiation (EMR) receiver; and one or more processors operatively coupled to the display and the EMR receiver, the one or more processors configured to cause the display, in a first mode of operation, to graphically render a navigation view, the navigation view including (i) a first informational element relating to a geographic location of the navigation device and (ii) one or both of a compass rose and a geographic map, and cause the display, in a second mode of operation and responsive to receiving an EMR signal via the EMR receiver, to render an informational view including a second informational element, the informational view at least partially obscuring the navigation view.

Example 2 includes the subject matter of Example 1, wherein the one or more processors are further configured to change from the second mode of operation to the first mode of operation responsive to a user input via a hardware switch of the navigation device.

Example 3 includes the subject matter of Example 2, wherein the one or more processors are further configured, in the second mode of operation, to cause the display to render one or more labels, at least one of the labels being associated with the hardware switch.

Example 4 includes the subject matter of any one of Examples 1-3, wherein the first informational element includes a waypoint marker.

Example 5 includes the subject matter of Example 4, wherein the waypoint marker is displayed on the compass rose or the geographic map as a bearing relative to a current geographical position of the navigation device.

Example 6 includes the subject matter of any one of Examples 1-5, wherein the one or more processors are further configured to render the informational view responsive to comparing a current geographical position of the navigation device to a geographic boundary or a positional phase line.

Example 7 includes the subject matter of any one of Examples 1-6, wherein the one or more processors are further configured to erase data from a memory responsive to a user input via a hardware switch of the navigation device.

Example 8 includes the subject matter of any one of Examples 1-7, wherein the EMR signal is at least one of a Global Positioning System (GPS) signal and a GPS jamming signal.

Example 9 includes the subject matter of any one of Examples 1-8, further comprising a case configured to contain the display and a wristband coupled to the case and configured to attach the case to a wrist of a user.

Example 10 includes the subject matter of Example 9, wherein a first set of hardware switches are located adjacent to a first side of the display and a second set of hardware switches are located adjacent to a second side of the display opposite the first side of the display.

Example 11 includes the subject matter of Example 10, wherein the one or more processors are further configured to activate a function of the device responsive to a user input via at least one hardware switch in the first set of hardware switches and at least one hardware switch in the second set of hardware switches.

Example 12 includes the subject matter of Example 11, wherein the user input includes a simultaneous press of the at least one hardware switch in the in the first set of hardware switches and of the at least one hardware switch in the second set of hardware switches.

Example 13 includes the subject matter of Example 12, wherein the at least one hardware switch in the in the first set of hardware switches and the at least one hardware switch in the second set of hardware switches are each located on a same side of the display.

Example 14 provides a method of operating a navigation device. The method comprises causing, by one or more processors in a first mode of operation, a display to graphically render a navigation view, the navigation view including (i) a first informational element relating to a geographic location of the navigation device and (ii) one or both of a compass rose and a geographic map, and causing, by the one or more processors in a second mode of operation and responsive to receiving an electromagnetic radiation (EMR) signal via an EMR receiver, the display to render an informational view including a second informational element, the informational view at least partially obscuring the navigation view.

Example 15 includes the subject matter of Example 14, further comprising changing, by the one or more processors, from the second mode of operation to the first mode of operation responsive to a user input via a hardware switch of the navigation device.

Example 16 includes the subject matter of Example 15, further comprising causing, by the one or more processors in the second mode of operation, the display to render one or more labels, at least one of the labels being associated with the hardware switch.

Example 17 includes the subject matter of any one of Examples 14-16, wherein the first informational element includes a waypoint marker.

Example 18 includes the subject matter of Example 17, wherein the waypoint marker is displayed on the compass rose or the geographic map as a bearing relative to a current geographical position of the navigation device.

Example 19 includes the subject matter of anyone of Examples 14-18, further comprising rendering, by the one or more processors, the informational view responsive to comparing a current geographical position of the navigation device to a geographic boundary or a positional phase line.

Example 20 includes the subject matter of any one of Examples 14-19, wherein the one or more processors are further configured to activate a function of the device responsive to a user input via at least one hardware switch in the first set of hardware switches and at least one hardware switch in the second set of hardware switches.

Numerous specific details have been set forth herein to provide a thorough understanding of the examples. It will be understood, however, that other examples may be practiced without these specific details, or otherwise with a different set of details. It will be further appreciated that the specific structural and functional details disclosed herein are representative of examples and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims. Furthermore, examples described herein may include other elements and components not specifically described, such as electrical connections, signal transmitters and receivers, processors, or other suitable components for operation of the modular antenna.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and examples have been described herein. The features, aspects, and examples are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

1. A navigation device, comprising:
a display;
an electromagnetic radiation (EMR) receiver; and
one or more processors operatively coupled to the display and the EMR receiver, the one or more processors configured to cause the display, in a first mode of operation, to graphically render a navigation view, the navigation view including (i) a first informational element relating to a geographic location of the navigation device, the first informational element further including information that an EMR signal received by the EMR receiver is being jammed or spoofed and (ii) one or both of a compass rose and a geographic map, and
cause the display, in a second mode of operation and responsive to receiving an EMR signal via the EMR receiver, to render an informational view including a second informational element, the informational view at least partially obscuring the navigation view.

2. The navigation device of claim 1, wherein the one or more processors are further configured to change from the second mode of operation to the first mode of operation responsive to a user input via a hardware switch of the navigation device.

3. The navigation device of claim 2, wherein the one or more processors are further configured, in the second mode of operation, to cause the display to render one or more labels, at least one of the labels being associated with the hardware switch.

4. The navigation device of claim 1, wherein the first informational element includes a waypoint marker.

5. The navigation device of claim 4, wherein the waypoint marker is displayed on the compass rose or the geographic map as a bearing relative to a current geographical position of the navigation device.

6. The navigation device of claim 1, wherein the one or more processors are further configured to render the informational view responsive to comparing a current geographical position of the navigation device to a geographic boundary or a positional phase line.

7. The navigation device of claim 1, wherein the one or more processors are further configured to erase data from a memory responsive to a user input via a hardware switch of the navigation device.

8. The navigation device of claim 1, wherein the EMR signal is at least one of a Global Positioning System (GPS) signal and a GPS jamming signal.

9. The navigation device of claim 1, further comprising a case configured to contain the display and a wristband coupled to the case and configured to attach the case to a wrist of a user.

10. The navigation device of claim 9, wherein a first set of hardware switches are located adjacent to a first side of the display and a second set of hardware switches are located adjacent to a second side of the display opposite the first side of the display.

11. The navigation device of claim 10, wherein the one or more processors are further configured to activate a function of the device responsive to a user input via at least one hardware switch in the first set of hardware switches and at least one hardware switch in the second set of hardware switches.

12. The navigation device of claim 11, wherein the user input includes a simultaneous press of the at least one hardware switch in the in the first set of hardware switches and of the at least one hardware switch in the second set of hardware switches.

13. The navigation device of claim 9, wherein the at least one hardware switch in a first set of hardware switches and the at least one hardware switch in second set of hardware switches are each located on a same side of the display.

14. A method of operating a navigation device, the method comprising:
causing, by one or more processors in a first mode of operation, a display to graphically render a navigation view, the navigation view including (i) a first informational element relating to a geographic location of the navigation device, the first informational element further including information that an EMR signal received by the EMR receiver is being jammed or spoofed and (ii) one or both of a compass rose and a geographic map, and
causing, by the one or more processors in a second mode of operation and responsive to receiving an electromagnetic radiation (EMR) signal via an EMR receiver, the display to render an informational view including a second informational element, the informational view at least partially obscuring the navigation view.

15. The method of claim 14, further comprising changing, by the one or more processors, from the second mode of operation to the first mode of operation responsive to a user input via a hardware switch of the navigation device.

16. The method of claim 15, further comprising causing, by the one or more processors in the second mode of operation, the display to render one or more labels, at least one of the labels being associated with the hardware switch.

17. The method of claim 14, wherein the first informational element includes a waypoint marker.

18. The method of claim 17, wherein the waypoint marker is displayed on the compass rose or the geographic map as a bearing relative to a current geographical position of the navigation device.

19. The method of claim 14, further comprising rendering, by the one or more processors, the informational view responsive to comparing a current geographical position of the navigation device to a geographic boundary or a positional phase line.

20. The method of claim 14, wherein the one or more processors are further configured to activate a function of the device responsive to a user input via at least one hardware switch in a first set of hardware switches and at least one hardware switch in a second set of hardware switches.
